(19) United States
(12) Patent Application Publication
(10) Pub. No.: US 2006/0010256 A1
(43) Pub. Date: Jan. 12, 2006

(54) Data processing system and method of operation

(75) Inventors: Dale R Heron, Surrey (GB); Karl J. Wood, Crawley (GB)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., BA Eindhoven (NL)

(21) Appl. No.: 10/528,943

(22) PCT Filed: Sep. 12, 2003
(86) PCT No.: PCT/IB03/04084

§ 371 Date: Mar. 23, 2005

(30) Foreign Application Priority Data
Sep. 28, 2002 (GB) 0222554.8

(51) Int. Cl. G06F 3/00

(52) U.S. Cl. 710/1

(57) ABSTRACT

A server-based data processing system (10) is provided for enabling interaction between users of a massive multi-player role playing game (MMRPG) or similar application in which a virtual environment (20) is represented geographically as a plurality of cells (22) arranged in a matrix for example. Game state data relating to the individual cells is broadcast from the server (12) to respective user-interface apparatus (14) such as mobile phone devices. Each cell is associated with one channel allowing the user-interface apparatus to receive the channel associated with the cell in which the respective user is represented. The association between cells of the virtual environment and broadcast channels enables the user-interface devices to reject unwanted state data by simply tuning to the desired channel. This is particularly beneficial for low power, low memory devices.

This invention relates to a data processing system for executing a multiple user game or other application in which users interact with one another in a cellularised virtual environment, and also video game or interaction apparatus for use therewith. In particular, the system is suited to games or applications taking place over a wide-area-network (WAN).

Massive multiplayer role playing games (MMRPG) software is readily available on the computer games market and is ever increasing in popularity. Users load the software onto personal user interface devices such as PCs allowing them to interact with other players (who also possess similar software) via a WAN and a central server. Such games commonly involve a virtual environment in which the players control a respective character moving around the environment interacting with other characters and with the “virtual” surroundings. The central server serves to communicate with the individual players over the WAN supplying them with game state data relating to the present state of the game. By way of example this may include the location of each character in the virtual environment, various attributes relating to other characters or virtual objects possessed by the characters.

The number of players that are involved in the game at any one time is a major contributory factor to the number and frequency of communications required between the server and the respective user interface devices of these players. This message traffic can be slowed down by low speed terminal connections for example and this effect becomes more apparent to each player as the number of players involved increases thus reducing the realism and enjoyment of the game for the users.

U.S. Pat. No. 6,025,801 describes a method and system for processing a multi-user software application and whose contents are incorporated herein by reference. In summary, a virtual environment is composed of adjacent geographic cells. Game state change is communicated to a user and which state change relates to the cell in which the user resides and to adjacent cells within a specified range.

However, it is not practical to send individual messages to the respective user-interface devices in the case of a MMRPG having a server which broadcasts game state data, or in the case of non-game applications.

It is therefore an object of the present invention to provide an improved data processing system for executing a multi-user application.

It is another object of the invention to provide a server-based multi-user application system capable of communicating state data via a broadcast WAN.

According to a first aspect of the present invention there is provided a data processing system comprising a server for processing a software application enabling interaction among multiple users sharing a virtual environment represented geographically as a plurality of cells, each user being represented at a virtual location in said environment, and a plurality of user-interface apparatus each for receiving state data relating to said environment from said server via a plurality of channels, wherein each cell is associated with one of said channels, and at least one of said user-interface apparatus is operable to receive the channel associated with the cell in which the respective user's representation is located. By communicating state data over a plurality of channels on a cell-by-cell basis, the user-interface apparatus can tune to the required channel so as to receive the state data relevant to the respective user and disregard other, less relevant channels. In this way, user-interface devices process less data during the application thus improving the efficiency of the data processing system and allowing the users to interact with one another in a more realistic manner. The association between the cells and the channels provides for a well structured data transfer method using a plurality of channels broadcast from the server.

Advantageously, at least some of the cells may overlap with adjacent cells. This allows a smoother transition in the supply of state data to a user as the user's representation moves from one cell to another. Therefore, when the representation is located in the overlap region of two adjacent cells, the respective user-interface apparatus can receive the channel associated with either one of the two cells. The cells can, by way of example, be arranged in a 2-D row and column matrix formation. To provide overlapping cells in a 2-D virtual environment the cells are preferably arranged in a first and a second matrix such that a cell in the first matrix overlies four cells in the second matrix. This allows each location in the virtual environment to be represented by at least two different cells each offset from one another.

In a system having more cells than available channels, more than one of the cells can be associated with one, or more, of the channels. Preferably, the cells are grouped geographically such that all cells relating to a particular channel represent one region in the virtual environment. This allows a user's representation to move from one cell to another in the group without the need for the respective user-interface to tune to a different channel. Alternatively, it may be found advantageous, depending on the application format and the virtual environment being represented, to group the cells in a different way. By way of example, the cells relating to a given channel may be arranged in an array wherein each cell is spaced from one another. In any such arrangement, at least one user-interface apparatus may be operable to disregard the remaining cells associated with that channel. This beneficially provides a further efficient way for the user-interface apparatus to process the state data received from the server. Having received the channel carrying the state data for the cell in which a user's representation is located, the respective user-interface apparatus can further refine the state data of that channel by ignoring that related to other, currently irrelevant, cells.

According to a second aspect of the present invention there is provided an interactivity apparatus for use with a remote server-based multiple user application in which the users share a virtual environment represented geographically as a plurality of cells and are each represented at a virtual location in said environment, the apparatus operable to communicate with the server via a plurality of channels, wherein each cell is associated with one of said channels, and the apparatus further comprises receiving means operable to receive the channel associated with the cell in which the respective user's representation is located.

According to a third aspect of the present invention there is provided a method of processing data for a multiple user application in which the users share a virtual environment represented geographically as a plurality of cells, the method comprising the steps of:
representing a user at a virtual location in said environment;
transmitting a plurality of channels, wherein each cell is associated with one of said channels and each channel conveys information relating to its respective associated cells;
receiving one of said channels, the received channel associated with the cell comprising said virtual location.

Advantageously, the method may further comprise the steps of:
detecting the direction of movement of said user's representation; and,
receiving another one of said channels which is associated with a neighbouring cell to that cell comprising said virtual location in accordance with said detected direction. By predicting the movement of the user's representation, a seamless supply of state data can be processed by the respective user-interface apparatus as the representation moves from cell to cell.

According to a fourth aspect of the present invention there is provided a computer game program for carrying out the above method.

Embodiments of the invention will now be described, by way of example only, with reference to the accompanying drawings, in which:

FIG. 1 shows schematically a data processing system;

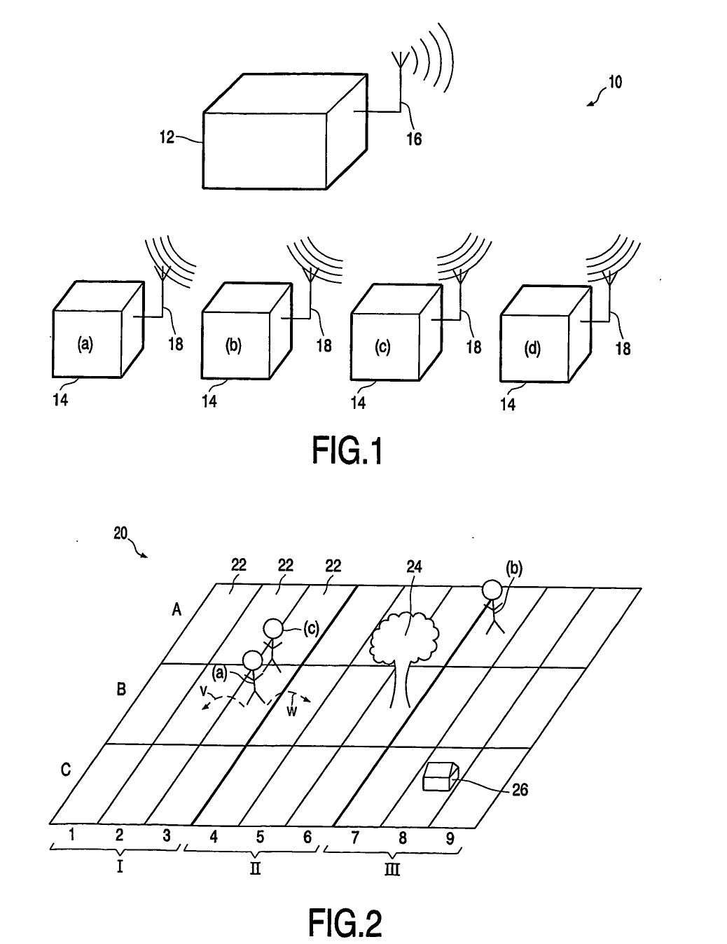

FIG. 2 is a schematic representation of a virtual environment represented geographically as a plurality of cells in a first arrangement;

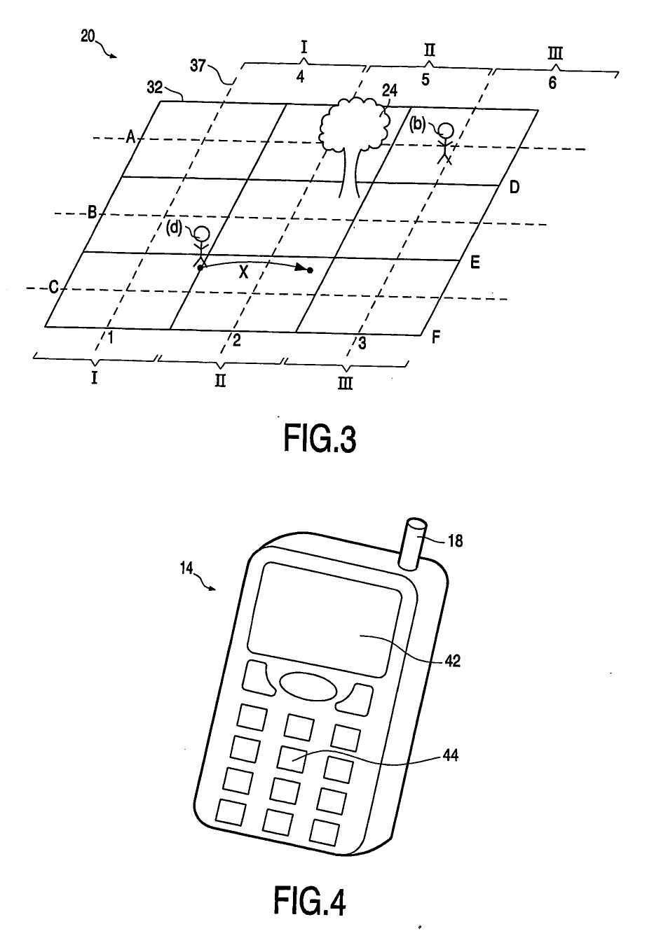

FIG. 3 is a schematic representation of a virtual environment represented geographically as a plurality of cells in a second arrangement;

FIG. 4 shows a mobile phone device for use with a remote server-based multiple user game; and

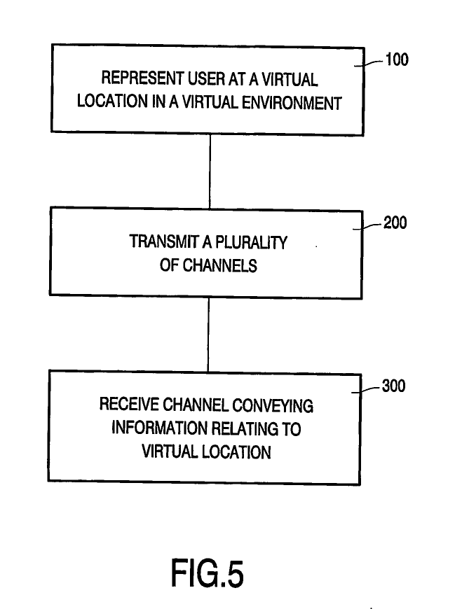

FIG. 5 is a flow diagram of a method of processing data for a multiple user game.

Referring to FIG. 1, a data processing system 10 comprises a server 12 and a plurality of user-interface apparatus 14. The server 12 has a transmitter 16 for broadcasting channels. Each user-interface apparatus 14 comprises a receiver 18 for receiving the broadcast channels from the server 12. The channels are broadcast as radio waves, each channel having a specified wavelength and bandwidth allowing the user-interface apparatus to tune into (thus receive) the desired channel. This embodiment has four user-interface devices but it should be appreciated that the system may comprise many hundreds. Two-way communication exists between the user-interface apparatus and the server. However, only the broadcast channels from the server are illustrated in FIG. 1 for the sake of explanation of this embodiment.

The operation of the system 10 will now be described with reference also to the process steps, 100, 200 and 300 shown in the flow-diagram of FIG. 5. The system 10 serves to execute a massive multiplayer role playing game (MMRPG) in which users interact with one another over a wide area network (WAN). Each respective user-interface apparatus 14 stores similar software locally to run the game. Interaction between users is enabled by communicating via the server 12.

It will be recognised that systems, methods and apparatus embodying the present invention are not restricted to use in game applications: the skilled reader will appreciate that other multi-user interactive applications such as internet shared spaces and chat rooms may also be facilitated.

Returning to the game example, the users of a MMRPG share a virtual environment represented geographically as a plurality of cells. One arrangement of such cells is illustrated in FIG. 2. The virtual environment 20 of the game is divided into a row and column array of 2-D cells 22, each cell 22 representing a region of the environment. For the purposes of this description, each cell 22 shown in FIG. 2 can be described by a 2-digit co-ordinate (A-C, 1-9).

Each user of the system 10 is represented at a virtual location in the environment 20 by a character. FIG. 2 shows the respective characters representing users (a) and (c) located at cell B3, and the character representing user (b) located at cell A7. As well as the user's representations, the virtual environment 20 supports objects and surroundings related to the particular MMRPG. A tree 24 is located at cell B6 and a treasure-chest 26 at cell C8 in this example.

Each cell 22 is associated with one of the channels broadcast from the server 12 such that the channel carries the state data related to the associated cells from the server to the user-interface apparatus 14. The cells 22 are arranged into groups, wherein each available channel carries the state data of a respective group of cells. In this example the server 12 broadcasts three channels. Channel I carries the state data related to the nine cells in columns 1, 2 and 3. Channel II carries the state data of the cells in columns 4, 5 and 6, and channel III carries the data from columns 7, 8 and 9.

The user-interface apparatus 14 are operable to receive the channel associated with the cell 22 in which the respective user's character is located. For example, the character of user-(a) is located in cell B3 of the virtual environment 20 in FIG. 2. The respective user-interface apparatus 14 of user-(a) receives the state data related to cell B3 by tuning into channel I which is broadcast by the server 12, i.e. the channel carrying the state data related to the cells in columns 1, 2 and 3. By tuning into this channel in this way, the user-interface apparatus 14 simply and efficiently rejects unwanted state data which relates to cells in the virtual environment not affecting user-(a) at that time. As can be seen from FIG. 2, the character of user-(c) is also located in cell B3 and so the respective user-interface apparatus 14 of user-(c) also tunes into the channel I. Each of users-(a) and -(c) receive state data related to one another allowing these two users to interact in the game. The user-interface apparatus of users-(a) and -(c) do not receive state data related to cells in columns 4 to 9 and thus they do not receive irrelevant data related to the tree 24 for example (located in cell B7) which does not affect users -(a) and -(c).

The user-interface apparatus of user-(a) is operable to disregard the remaining cells associated with channel I. Therefore, cells A1-A3, B1, B2 and C1-C3 are disregarded by the apparatus 14 and the state data related to cell B3 is processed having been extracted from that channel. Again, this allows the user-interface apparatus 14 to process a minimal quantity of state data. This is particularly beneficial to low power devices such as mobile phones which do not have the ability to process large quantities of data.

During the game each user may move their respective character from one cell 22 to another in the virtual environment. With such movement the respective user-interface apparatus 14 must acquire state data relating to the new cell. Referring again to FIG. 2 and by way of example, the movement of the character of user-(a) from cell B3 to cell B2, as indicated by the dashed arrow V, requires the user-interface apparatus of user-(a) to receive and process state data related to cell B2 which is carried by the same channel (I). Therefore, the user-interface apparatus of user-(a) is not required to tune to a different channel but may disregard the state data related to cell B3 once the movement is complete.

However, if user-(a) moves from cell B3 to B4 instead, as indicated by the dashed arrow W, the user-interface apparatus of user-(a) must tune into channel II in order to receive state data relating to new cell B4.

Transitions from cell to cell may require the respective user-interface apparatus 14 to receive state data related to more than one cell simultaneously so as to provide a seamless processing of such state data. Also a user may be able to view the virtual environment of a neighbouring cell, or beyond, without actually being represented in that cell. For example, user-(b) represented at cell A7 should be able to view the tree 24 in cell B6. This requires the user-interface apparatus (b) to receive both channels II and III simultaneously.

FIG. 3 shows an alternative cell arrangement to that shown in FIG. 2. The virtual environment 20 is represented by two overlapping row and column matrices of cells wherein one matrix of cells 32 defined by the solid lines and described by co-ordinates (A-C,1-3), overlies a second matrix of cells 37 defined by dashed lines and described by co-ordinates (D-F, 4-6). The cells in both matrices are of equal size but the matrices are offset from one another such that a cell in the first matrix overlies a part of four cells in the second matrix. Therefore, each location in the virtual environment is represented by two different cells each from the two separate matrices (32, 37).

As with the arrangement of FIG. 2, each cell in FIG. 3 is associated with one of the channels. The cells are also grouped in a similar manner. Cells in column 1 (of the first matrix 32) are associated with channel I for example. However, cells in column 4 (of the second matrix) are also associated with channel I. Likewise, cells in columns 2 and 5 are associated with channel II, and columns 3 and 6 with channel III. Each channel carries state data, related to its associated cells, from the server 12 to the user-interface apparatus 14.

A cell arrangement of this type allows smooth transitions in state data processing by the user-interface apparatus as the user's characters move around the virtual environment 20 from cell to cell. By way of example, the character of user-(d) moves under the control of the respective user in a path through the virtual environment 20 as indicated by arrow X shown in FIG. 3.

Initially, the character is located completely in cell E4. The cell is related to channel I and so user-interface apparatus of user-(d) is tuned to receive this channel.

The fact that the character is located partially in both cells C1 and C2 (requiring simultaneous tuning to channels I and II in the embodiment of FIG. 2) does not cause a problem to the user-interface apparatus due to the double-matrix cell arrangement.

As the character moves from its initial location in the direction of arrow X, the respective user-interface apparatus detects this direction of movement and, as soon as the representation is completely in cell C2, accordingly tunes to receive channel II instead. Because the region shared by both cells E4 and C2 is associated by both channels I and II, tuning from one channel to the other, triggered by the sensed direction of travel, provides a seamless supply of state data related to the relevant cells.

In a similar manner to that of user-(d), the respective user-interface apparatus for user-(b) is tuned to receive only channel III as the character of user-(b) is located completely in cell A3.

The cells can be arranged in many different ways for both 2-D and 3-D representations of a virtual environment in MMRPGs and variations will be apparent to persons skilled in the art.

FIG. 4 shows a mobile phone device which serves as user-interface apparatus for the data processing system described above. The device 14 comprises receiving means 18 in the form of an aerial. A user can view the virtual environment of the game being played on the display 42. The representation of the user can be controlled and various other instructions related to the game by operation of the key-pad 44.

In summary, the aforementioned describes a server-based data processing system for enabling interaction between users of a MMRPG or similar application in which a virtual environment is represented geographically as a plurality of cells arranged in a matrix for example. Game state data relating to the individual cells is broadcast from the server to respective user-interface apparatus such as mobile phone devices. Each cell is associated with one channel allowing the user-interface apparatus to receive the channel associated with the cell in which the respective user is represented. The association between cells of the virtual environment and broadcast channels enables the user-interface devices to reject unwanted state data by simply tuning to the desired channel. This is particularly beneficial for low power, low memory devices.

From the present disclosure, many other modifications and variations will be apparent to persons skilled in the art. Such modifications and variations may involve other features which are already known in the art and which may be used instead of or in addition to features already disclosed herein.

1. A data processing system 10 comprising a server 12 for processing a software application enabling interaction among multiple users sharing a virtual environment 20 represented geographically as a plurality of cells 22, each user being represented at a virtual location in said environment, and a plurality of user-interface apparatus 14 each for receiving state data relating to said environment from said server via a plurality of channels, wherein each cell 22 is associated with one of said channels, and at least one of said user-interface apparatus 14 is operable to tune to one of said channels so as to receive the channel associated with the cell in which the respective users representation is located.

2. A system according to claim 1, wherein at least some of said cells overlap with adjacent cells.

3. A system according to claim 1 or 2, wherein said cells are arranged in a 2-D row and column matrix formation.

4. A system according to claim 3, wherein said cells are arranged in a first and a second matrix 32,37 such that a cell in the first matrix overlies four cells in the second matrix.

5. A system according to any preceding claim, wherein more than one of said cells 22 are associated with one of said channels.

6. A system according to claim 5, wherein said at least one user-interface apparatus is operable to disregard the remaining cells associated with that channel.

7. Interactivity apparatus 14 for use with a remote server-based multiple user application in which the users share a virtual environment 20 represented geographically as a plurality of cells 22 and are each represented at a virtual location in said environment, the apparatus operable to communicate with the server via a plurality of channels, wherein each cell is associated with one of said channels, and the apparatus further comprises receiving means 18 operable to tune to one of said channels so as to receive the channel associated with the cell in which the respective user's representation is located.

8. A mobile phone device comprising the apparatus of claim 7.

9. A method of processing data for a multiple user application in which the users share a virtual environment 20 represented geographically as a plurality of cells 22, the method comprising the steps of:
representing a user at a virtual location in said environment;
transmitting a plurality of channels, wherein each cell is associated with one of said channels and each channel conveys information relating to its respective associated cells; and,
tuning to one of said channels so as to receive the channel associated with the cell comprising said virtual location.

10. A method according to claim 9 further comprising the steps of:
detecting the direction of movement of said user's representation; and,
receiving another one of said channels which is associated with a neighbouring cell to that cell comprising said virtual location in accordance with said detected direction.

11. A computer program for carrying out the method of claim 9 or claim 10.
